(19) United States
(12) Patent Application Publication
(10) Pub. No.: US 2008/0303406 A1
(43) Pub. Date: Dec. 11, 2008

(54) Image Display Device and Manufacturing Method of the Same

(76) Inventors: Hiroyasu YANASE, Mobara (JP); Etsuko Nishimura, Hitachiota (JP); Toshiaki Kusunoki, Tokorozawa (JP); Tomoki Nakamura, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/107,799

(22) Filed: Apr. 23, 2008

(30) Foreign Application Priority Data
Apr. 25, 2007 (JP) 2007-115955

(51) Int. Cl. H01J 63/04

(52) U.S. Cl. 313/495

(57) ABSTRACT

The present invention provides an image display device which can lower the resistance of scanning signal lines, can ensure the enhancement of reliability of supply of electricity and conductivity and the reliability of separation of elements, can exhibit excellent display characteristic, and can possess an extremely prolonged lifetime. The scanning signal line has the stacked film structure constituted of a lower layer film formed of an aluminum film and an upper layer film formed of an aluminum alloy film containing aluminum as a main component.

### CLAIM OF PRIORITY

The present application claims priority from Japanese Application JP 2007-115955 filed on Apr. 25, 2007, the content of which is hereby incorporated by reference into this application.

### BACKGROUND OF THE INVENTION

1. Field of the Invention

The present invention relates to a self-luminous flat-panel-type image display device, and more particularly to an image display device which arranges thin-film-type electron sources in a matrix array.

2. Description of the Related Art

As one self-luminous -type flat panel display (FPD) having electron sources which are arranged in a matrix array, an electric field emission type image display device (FED: Field Emission Display) which uses minute integrative cold cathodes and an electron emission type image display device have been known.

As the cold cathode, there have been known a thin film-type electron source such as a Spindt-type electron source, a surface-conducive-type electron source, a carbon-nanotube-type electron source, an MIM (Metal-Insulator-Metal) type electron source which is formed by stacking a metal layer, an insulator and a metal layer in this order, an MIS (Metal-Insulator-Semiconductor) type electron source which is formed by stacking a metal layer, an insulator and a semiconductor in this order or a metal layer-insulator-semiconductor-metal layer type electron source.

The self-luminous-type FPD used in general includes a back panel which arranges the above-mentioned electron sources on a back substrate formed of a glass plate, a face panel which arranges phosphor layers and an anode for generating an electric field which allows electrons emitted from the electron sources to impinge on the phosphor layers on a face substrate made of a light transmissive material such as glass preferably, and a frame body which maintains an inner space defined between both facing panels at a predetermined distance, wherein the FPD is configured to maintain an inner space including a display region defined by the both panels and the frame body in a vacuum state. The FPD is constituted by combining a drive circuit with the display panel.

Further, on the back substrate of the back panel, a plurality of video signal lines which extend in one direction and are arranged in parallel to each other in another direction orthogonal to the one direction, an insulation film which is formed to cover the video signal lines, and a plurality of scanning signal lines which extend in the another direction and are arranged in parallel to each other in the one direction which intersects the video signal lines on the insulation film and to which scanning signals are applied sequentially are formed. Further, in general, the electron sources are arranged in the vicinity of the respective intersecting portions of the scanning signal lines and the image signal lines, the scanning signal lines and the electron sources are connected to each other by power supply electrodes, and an electric current is supplied to the electron sources from the scanning signal lines.

Further, the individual electron source forms a pair with a corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In addition to the above-mentioned constitution, in the image display device as described above, in the inside of a reduced pressure region including the display region which is arranged between the back panel and the face panel and is surrounded by the frame body, a plurality of distance holding members (spacers) are arranged and fixed. The distance between the above-mentioned both substrates is held at a predetermined distance in cooperation with the frame body. The spacers are formed of a plate-like body made of an insulation material such as glass, ceramics, or a material having some conductivity in general. Usually, the spacers are arranged at positions which do not impede an operation of pixels for every plurality of pixels.

Further, the frame body which constitutes a sealing frame is fixed to respective inner peripheries between the back substrate and the face substrate using a sealing material such as frit glass, and the fixing portions are hermetically sealed thus forming a sealing region. The degree of vacuum in the inside of a reduced pressure region defined by the both substrates and the frame body is set to approximately 10⁻⁵ to 10⁻⁷ Torr, for example.

Scanning-signal-line lead terminals which are connected to the scanning signal lines formed on the back substrate and image-signal-line lead terminals which are connected to the image signal lines formed on the back substrate respectively penetrate the sealing regions defined between the frame body and both substrates.

The above-mentioned MIM-type electron sources are disclosed in patent JA-A-2004-363075 (document 1) and JP-A-107741 (patent document 2), for example. The structure and the manner of operation of the MIM-type electron source are explained hereinafter. That is, the MIM-type electron source is constituted of an upper electrode and a lower electrode with an insulation layer interposed therebetween, and by applying a voltage between the upper electrode and the lower electrode, electrons having energy close to the Fermi level in the lower electrode pass through a barrier due to a tunnel phenomenon, are injected into a conductive band of the insulation layer which constitutes an electron acceleration layer and become hot electrons, and the hot electrons flow into a conductive band of the upper electrode. Here, out of these hot electrons, the electrons which arrive at a surface of the upper electrode while having the energy equal to or more than a work function φ of the upper electrode are emitted into a vacuum.

### SUMMARY OF THE INVENTION

The image display device is constituted by arranging such electron sources in a plurality of rows (horizontal direction, for example) as well as in a plurality of columns (vertical direction, for example) forming a matrix, and by disposing a large number of phosphor layers arranged corresponding to the respective electron sources in a vacuum.

In performing an image display in the image display device having such a constitution, a driving method which is referred to as a line sequential driving method is adopted as a standard method.

This method is a method which performs a display in each frame for every scanning signal line (horizontal direction) at the time of displaying 60 still images (60 frames) for every second. Accordingly, all of electron sources corresponding to the number of vide signal lines on the same scanning signal line are simultaneously operated. During such an operation, an electric current which is obtained by multiplying an electric current which the electron source included in a sub pixel (a sub pixel constituting color 1 pixel for full color display) consumes with the total number of video signal lines flows in the scanning signal lines. This scanning signal line current causes voltage drop along the scanning signal line due to line resistance thus impeding a uniform operation of the electron source. Particularly, voltage drop attributed to the line resistance of the scanning signal line becomes a crucial problem in realizing a large-sized display device.

To overcome this drawback, it is necessary to decrease the line resistance of the scanning signal line. In case of a thin-film-type electron source, it may be possible to lower the resistance of an upper bus electrode line (scanning signal line) for supplying electricity to a lower electrode (video signal electrode) or an upper electrode. However, when the thickness of the lower electrode is increased to lower the resistance, unevenness of the line becomes conspicuous thus giving rise to drawbacks on reliability such as lowering of the quality of an electron acceleration layer or the tendency of easy disconnection of the upper bus electrode or the like. Accordingly, it is preferable to adopt a method which lowers the resistance of the upper bus electrode line.

To lower the line resistance of the upper bus electrode line, it is effective to form the upper bus electrode line by using a thick film material having small specific resistance. Copper (Cu) exhibits the smallest specific resistance next to silver (Ag), is obtainable at a low cost, and can obtain a large film thickness because of a rapid sputter film forming speed. Further, Cu enables the formation of a thick film also by a plating method and hence, Cu is a material suitable for forming the upper bus electrode line. However, Cu is easily oxidized and hence, when Cu is applied to an FED panel, for example, Cu is easily oxidized in a high-temperature sealing step. Accordingly, it may be possible to sandwich upper and lower sides of Cu with a metal having high heat resistance and high oxidation resistance so as to prevent the oxidation of Cu. However, although most of Cu may be prevented from oxidation thereof by sandwiching upper and lower sides of Cu with a metal which exhibits high oxidation resistance, the oxidation of side surfaces of the line cannot be prevented. Although it is desirable that the upper bus electrode line also has a mechanism for separating the upper electrode in a self-aligning manner, due to the oxidation of side surfaces of the line, there may be a case that an undercut portion formed by Cu and a lower-layer film is deformed thus deteriorating the pixel separation characteristic.

Further, to lower the line resistance of the upper bus electrode line, it is also effective to use a silver (Ag) or gold (Au) electrode formed by screen printing, for example. Further, the upper bus electrode line is required to possess the structure which separates the upper electrode in a self-aligning manner, to arrange spacers, and to possess a function of a spacer electrode which prevents charging of the spacers and prevents mechanical damages on the lower-layer lines or the like due to an atmospheric pressure applied to the spacers (function of electrically connecting spacers with the upper bus electrode line). However, it is difficult for the screen printing to form the complicated structure for realizing the pixel separation characteristic which separates the upper electrode in a self-aligning manner.

Although patent documents 1 and 2 disclose a technique which stacks a thick film line made of Ag or the like by screen printing or the like on a thin film line formed by a vacuum film forming method or the like. However, when the screen-printed line is formed using a paste made of Ag, Au or the like, in baking the paste, high-temperature heat treatment is performed in a state that oxygen is present such as an atmospheric atmosphere for burning out a binder. Accordingly, a surface of the thin film is oxidized and hence, the contact resistance between the thin film and the thick film line is increased thus giving rise to a drawback that the resistance cannot be decreased substantially.

Further, patent document 2 discloses the constitution which uses aluminum (Al) or aluminum alloy (Al alloy) having high oxidation resistance as a low resistance material, and upper and lower electrodes are made of chromium (Cr), chromium alloy (Cr alloy) or the like having high oxidation resistance and a nobler standard electrode potential than Al.

That is, patent document 2 discloses the following manufacturing method of an image display device. Cr, Cr alloy or the like is selectively etched with respect to Al or Al alloy, wherein an electrode made of Cr, Cr alloy or the like forming a lower layer projects on one side thereof, and is undercut on another side thereof with respect to the Al or Al alloy electrode. The undercut is formed by selectively etching by wet etching the metal material such as Cr, Cr alloy or the like having a nobler electrode potential than Al or Al alloy having a base electrode potential. Accordingly, by setting the film thickness of the upper Cr or Cr alloy layer larger than the film thickness of the lower Cr or Cr alloy layer or by limiting the exposure quantity of Al or Al alloy which is not covered with the upper Cr or Cr alloy layer, a regional battery action between the Al or Al alloy and Cr or Cr alloy can be controlled thus ensuring a proper undercut quantity.

Due to such constitution, the deformation of the undercut portion can be suppressed and hence, the self-aligning separation characteristic of the upper electrode can be enhanced. Further, the pixel separation characteristic is not degraded even when the electrodes are subject to high-temperature heat treatment in the atmosphere containing oxygen such as a sealing step of an image display device and hence, it is possible to form the upper bus electrode line (scanning signal line) with low resistance. Accordingly, it is possible to acquire an image having uniform brightness within a display region.

However, the constitution described in patent document 2 having the above-mentioned technical features is also required to simultaneously perform two different processings, that is, undercut processing for separating elements applied to one side wall of the scanning signal line lower layer Cr and taper forming processing for ensuring a contact applied to another side wall of the scanning signal line lower layer Cr and hence, formability is inevitably lowered.

Further, when the taper forming processing is insufficient, there exists a possibility of disconnection of the upper electrode, and the occurrence of disconnection brings about the failure of supply of electricity to electron sources.

Further, the scanning signal line lower layer Cr is oxidized due to the influence of the heat treatment which the lower layer Cr receives in the panel sealing step and hence, there exists a possibility of fluctuation of conductivity or the occurrence of conductive failure. Under such circumstances, there has been a demand for a technique which can overcome such drawbacks.

Accordingly, it is an object of the present invention to provide an image display device which can overcome the above-mentioned drawbacks, and can ensure the enhancement of reliability of supply of electricity and conductivity, can ensure the reliability of separation of elements, can shorten manufacturing steps, and can exhibit excellent display characteristic, and can possess an extremely prolonged lifetime.

To achieve the above-mentioned object, the present invention provides an image display device which includes: a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of the intersecting portions of the video signal lines and the scanning signal lines thereon and connected to the scanning signal lines; a face substrate which mounts phosphor layers formed corresponding to the electron sources and an anode for applying an acceleration voltage so as to direct electrons emitted from the electron sources to the phosphor layers thereon; a frame body being arranged between the face substrate and the back substrate for holding a predetermined distance between the both substrates; and a sealing material for hermetically sealing the frame body and the both substrates, wherein the scanning signal line has the stacked film structure constituted of an aluminum film and an aluminum alloy film containing aluminum as a main component.

Further, the present invention also provides an image display device which includes: a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of the intersecting portions of the video signal lines and the scanning signal lines thereon and connected to the scanning signal lines; a face substrate which mounts phosphor layers formed corresponding to the electron sources and an anode for applying an acceleration voltage so as to direct electrons emitted from the electron sources to the phosphor layers thereon; and a frame body provided being arranged between the face substrate and the back substrate for holding a predetermined distance between the both substrates; and a sealing material for hermetically sealing the frame body and the both substrates, wherein the scanning signal line has the stacked film structure constituted of an aluminum alloy film containing aluminum as a main component, and includes a plurality of layers which have different specific resistances in the stacked film structure.

By forming the scanning signal line into the stacked film structure formed of the aluminum film and the aluminum alloy film containing aluminum as a main component, taper processing for ensuring a contact can be performed more easily compared to taper processing for ensuring a contact applied to chromium and hence, the processing accuracy and processing property can be enhanced thus obviating the generation of disconnection of the upper electrode.

Further, the increase of resistance which aluminum receives in heat treatment at the time of sealing the panel or the like is lowered compared to the increase of resistance which chromium receives thus enhancing the reliability of electric conductivity.

Further, the contamination of electron sources attributed to the volatilization of chromium can be obviated thus ensuring the reliability of electron radiation characteristic and realizing the prolongation of lifetime.

Still further, by forming the scanning signal line into the stacked structure formed of aluminum alloy having aluminum alloy films which have different specific resistances, not to mention the above-mentioned advantageous effects, it is possible to enhance the reliability of holding an eaves shape of an undercut portion thus ensuring the reliability of element separation.

### BRIEF DESCRIPTION OF THE DRAWINGS

FIG. 1A and FIG. 1B are schematic views for explaining the constitution of an embodiment of an image display device according to the present invention, wherein FIG. 1A is a plan view and FIG. 1B is a side view of the image display device shown in FIG. 1A;

FIG. 2 is a schematic cross-sectional view taken along a line A-A in FIG. 1B;

FIG. 3 is a schematic cross-sectional view of a portion of a back substrate and a portion of a face substrate corresponding to the portion of the back substrate taken along a line B-B in FIG. 2;

FIG. 4A, FIG. 4B and FIG. 4C are schematic views for explaining manufacturing steps of the image display device according to the present invention, wherein FIG. 4A is a plan view, FIG. 4B is a cross-sectional view taken along a line C-C in FIG. 4A, and FIG. 4C is a cross-sectional view taken along a line D-D in FIG. 4A;

FIG. 5A, FIG. 5B and FIG. 5C are views for explaining manufacturing steps of the image display device according to the present invention, wherein FIG. 5A is a plan view, FIG. 5B is a cross-sectional view taken along a line C-C in FIG. 5A, and FIG. 5C is a cross-sectional view taken along a line D-D in FIG. 5A;

FIG. 6A, FIG. 6B and FIG. 6C are views for explaining manufacturing steps of the image display device according to the present invention, wherein FIG. 6A is a plan view, FIG. 6B is a cross-sectional view taken along a line C-C in FIG. 6A, and FIG. 6C is a cross-sectional view taken along a line D-D in FIG. 6A;

FIG. 7A, FIG. 7B and FIG. 7C are views for explaining manufacturing steps of the image display device according to the present invention, wherein FIG. 7A is a plan view, FIG. 7B is a cross-sectional view taken along a line C-C in FIG. 7A, and FIG. 7C is a cross-sectional view taken along a line D-D in FIG. 7A;

FIG. 8A, FIG. 8B and FIG. 8C are views for explaining manufacturing steps of the image display device according to the present invention, wherein FIG. 8A is a plan view, FIG. 8B is a cross-sectional view taken along a line C-C in FIG. 8A, and FIG. 8C is a cross-sectional view taken along a line D-D in FIG. 8A;

FIG. 9A, FIG. 9B and FIG. 9C are views for explaining manufacturing steps of the image display device according to the present invention, wherein FIG. 9A is a plan view, FIG. 9B is a cross-sectional view taken along a line C-C in FIG. 9A, and FIG. 9C is a cross-sectional view taken along a line D-D in FIG. 9A;

FIG. 10A, FIG. 10B and FIG. 10C are views for explaining manufacturing steps of the image display device according to the present invention, wherein FIG. 10A is a plan view, FIG. 10B is a cross-sectional view taken along a line C-C in FIG. 10A, and FIG. 10C is a cross-sectional view taken along a line D-D in FIG. 10A;

FIG. 11A, FIG. 11B and FIG. 11C are views for explaining manufacturing steps of the image display device according to the present invention, wherein FIG. 11A is a plan view, FIG. 11B is a cross-sectional view taken along a line C-C in FIG. 11A, and FIG. 11C is a cross-sectional view taken along a line D-D in FIG. 11A;

FIG. 12A, FIG. 12B and FIG. 12C are views for explaining manufacturing steps of the image display device according to the present invention, wherein FIG. 12A is a plan view, FIG. 12B is a schematic cross-sectional view taken along a line C-C in FIG. 12A, and FIG. 12C is a cross-sectional view taken along a line D-D in FIG. 12A;

FIG. 13A, FIG. 13B and FIG. 13C are views for explaining manufacturing steps of the image display device according to the present invention, wherein FIG. 13A is a plan view, FIG. 13B is a schematic cross-sectional view taken along a line C-C in FIG. 13A, and FIG. 13C is a cross-sectional view taken along a line D-D in FIG. 13A;

FIG. 14A, FIG. 14B and FIG. 14C are views for explaining manufacturing steps of the image display device according to the present invention, wherein FIG. 14A is a plan view, FIG. 14B is a schematic cross-sectional view taken along a line C-C in FIG. 14A, and FIG. 14C is a cross-sectional view taken along a line D-D in FIG. 14A;

FIG. 15A, FIG. 15B and FIG. 15C are views for explaining manufacturing steps of the image display device according to the present invention, wherein FIG. 15A is a plan view, FIG. 15B is a schematic cross-sectional view taken along a line C-C in FIG. 15A, and FIG. 15C is a cross-sectional view taken along a line D-D in FIG. 15A;

FIG. 16A, FIG. 16B and FIG. 16C are views for explaining manufacturing steps of another embodiment of the image display device according to the present invention, wherein FIG. 16A is a plan view, FIG. 16B is a schematic cross-sectional view taken along a line C-C in FIG. 16A, and FIG. 16C is a cross-sectional view taken along a line D-D in FIG. 16A;

FIG. 17A, FIG. 17B and FIG. 17C are schematic views for explaining another embodiment of the image display device according to the present invention, wherein FIG. 17A is a plan view, FIG. 17B is a cross-sectional view taken along a line C-C in FIG. 17A, and FIG. 17C is a cross-sectional view taken along a line D-D in FIG. 17A; and

FIG. 18 is a schematic cross-sectional view showing another embodiment of the image display device according to the present invention.

### DESCRIPTION OF THE PREFERRED EMBODIMENTS

Hereinafter, the present invention is explained in detail in conjunction with drawings showing several embodiments.

### Embodiment 1

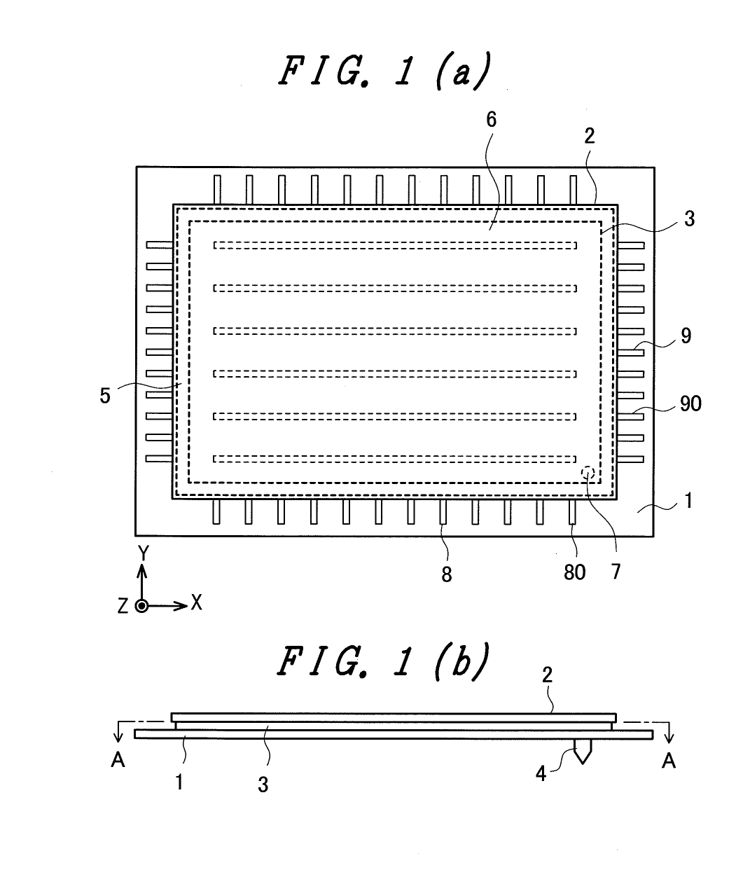

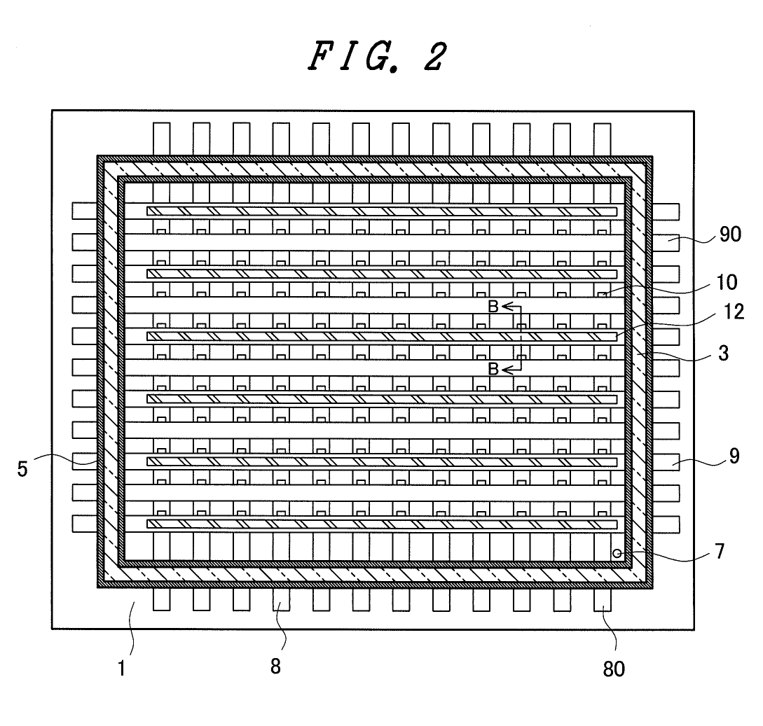

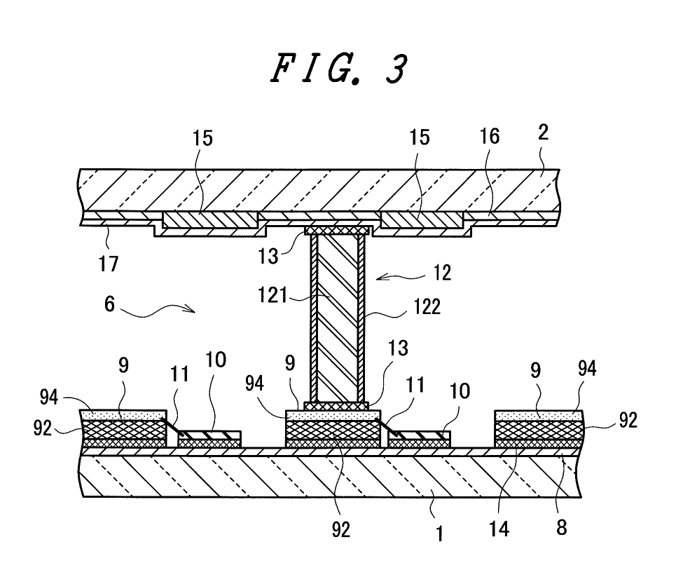

FIG. 1A to FIG. 3 are schematic views for explaining the constitution of an embodiment of an image display device according to the present invention, wherein FIG. 1A is a plan view, FIG. 1B is a side view of the image display device shown in FIG. 1A, FIG. 2 is a cross-sectional view taken along a line A-A in FIG. 1B, and FIG. 3 is a schematic cross-sectional view of a portion of a back substrate and a portion of a face substrate corresponding to the portion of back substrate taken along a line B-B in FIG. 2.

In FIG. 1 to FIG. 3, numeral 1 indicates the back substrate, numeral 2 indicates the face substrate, numeral 3 indicates a frame body, numeral 4 indicates an exhaust pipe, numeral 5 indicates a sealing material, numeral 6 indicates a vacuum region including a display region, numeral 7 indicates a through hole, numeral 8 indicates video signal lines, numeral 9 indicates scanning signal lines, numeral 10 indicates electron sources, numeral 11 indicates connection lines, numeral 12 indicates spacers, numeral 13 indicates adhesive materials, numeral 14 indicates an interlayer insulation film, numeral 15 indicates phosphor layers, numeral 16 indicates a light-blocking BM (black matrix) film, and numeral 17 indicates a metal back (an anode electrode) formed of a metal thin film.

The back substrate 1 and the face substrate 2 have a substantially rectangular shape, and are respectively formed of a glass substrate having a thickness of several mm, for example, approximately 1 to 10 mm.

Numeral 3 indicates the frame body having a frame shape, and the frame body 3 is formed of, for example, a frit glass sintered body, a glass plate or the like. The frame body 3 is formed by a single body or by a combination of a plurality of members and is formed in an approximately rectangular shape. Further, the frame body 3 is interposed between the above-mentioned both substrates 1, 2.

Further, the frame body 3 is interposed between peripheral portions of the both substrates 1, 2, and both end surfaces of the frame body 3 are hermetically bonded to the both substrates 1, 2. A thickness of the frame body 3 is set to a value which falls in a range from several mm to several ten mm, and a height of the frame body 3 is set to a value substantially equal to a distance between the both substrates 1, 2.

Numeral 4 indicates the exhaust pipe which is fixedly secured to the back substrate 1.

Numeral 5 indicates the sealing material. The sealing material 5 is made of low-melting-point frit glass. For example, there has been known the sealing material 5 consisting of 75 to 80 wt % of PbO, approximately 10 wt % of B2O3, 10 to 15 wt % of balance and containing an amorphous-type frit glass or the like. The sealing material 5 joins the frame body 3 and the both substrates 1, 2 thus hermetically sealing a space defined by the frame body 3 and both substrates 1, 2.

The vacuum region 6 including the display region surrounded by the frame body 3, the both substrates 1, 2 and the sealing material 5 is evacuated through the exhaust pipe 4 to create and hold a degree of vacuum of, for example, 10⁻⁵ to 10⁻⁷ Torr. Further, the exhaust pipe 4 is mounted on an outer surface of the back substrate 1 as mentioned previously and is communicated with the through hole 7 which is formed in the back substrate 1 in a penetrating manner. After completing the evacuation, the exhaust pipe 4 is sealed.

Numeral 8 indicates the stripe-shaped video signal lines. The video signal lines 8 are formed of an aluminum (Al) film, an alloy film made of aluminum and neodymium (Al—Nd) or the like. The video signal lines 8 extend in one direction (Y direction) and are arranged in parallel to each other in another direction (X direction) on an inner surface of the back substrate 1. As described later, a tunnel insulation layer and a field insulation film are formed on an upper surface of the video signal lines 8. The video signal lines 8 hermetically penetrate a sealing region between the frame body 3 and the back substrate 1 from the vacuum region 6 and extend to an end portion on a long side of the back substrate 1, and the video signal lines 8a have distal end portions thereof formed into video-signal-line lead terminals 80.

Numeral 9 indicates the stripe-shaped scanning signal lines. The scanning signal lines 9 extend over the video signal lines 8 in the above-mentioned another direction (X direction) which intersects the video signal lines 8 and are arranged in parallel to each other in the above-mentioned one direction (Y direction). Although a detailed explanation of the scanning signal lines 9 is described later, the scanning signal line 9 has the stacked film structure constituted by stacking the an aluminum film 92 and an aluminum alloy film 94 containing aluminum as a main component or has the stacked film structure constituted by stacking aluminum alloy films having different specific resistances. The scanning signal lines 9 hermetically penetrate the sealing region between the frame body 3 and the back substrate 1 from the vacuum region 6 and extend to an end portion of a short side of the back substrate 1. The scanning signal lines 9 have distal end portions thereof formed into scanning signal line lead terminals 90.

Numeral 10 indicates the electron sources and the electron source 10 is an MIM-type electron source which forms one kind of electron source disclosed in patent documents 1, 2, for example. The electron sources 10 are formed in the vicinity of respective intersecting portions of the scanning signal lines 9 and the video signal lines 8. The electron source 10 is formed on a portion of the video signal line 8 on which the tunnel insulation layer is mounted. The electron sources 10 are connected to the scanning signal lines 9 via the connection lines 11.

Further, the interlayer insulation film 14 is arranged between the video signal line 8 and the scanning signal line 9. The inter layer insulation film 14 may be made of, for example, silicon oxide, silicon nitride, silicon or the like.

Next, numeral 12 indicates the spacers, and the spacers 12 are made of an insulation material such as a ceramic material. The spacer 12 is constituted of an insulation base body 121 which exhibits small non-uniform distribution of the resistance value and has a rectangular thin plate shape, and a coating film layer 122 which covers the surface of the insulation base body 121a and exhibits small non-uniform distribution of the resistance value.

The spacer 12 possesses a resistance value of approximately 10⁸ to 10⁹ Ω·cm and exhibits small non-uniform distribution of the resistance value as a whole.

The spacers 12 are arranged upright on the scanning signal lines 9 in substantially parallel to the frame body 3 for every one other line and are fixed by adhesion to the both substrates 1, 2 using the adhesive member 13.

The fixing by adhesion of the spacers 12 to the substrates may be performed on only one end side of the substrates and, further, the spacers 12 are arranged, in general, for every other plurality of pixels at positions at which the spacers do not impede operations of pixels.

Sizes of the spacers 12 are set based on sizes of substrates, a height of the frame body 3, materials of the substrates, an arrangement interval of the spacers, a material of spacers and the like. However, in general, the height of the spacers is approximately equal to the height of the frame body 3. A thickness of the spacer 12 is set to several 10 μm to several mm or less, while a length of the spacer 12 is set to approximately 20 mm to 1000 mm. Although the length of the spacer 12 may be set to more than 1000 mm, preferably, a practical value of the length is approximately 80 mm to 300 mm.

On the other hand, on an inner surface of the face substrate 2 to which one end sides of the spacers 12 are fixed, phosphor layers 15 of red, green and blue are formed in a state that these phosphor layers 15 are arranged in window portions defined by a light-shielding BM (black matrix) film 16. A metal back (anode electrode) 17 made of a metal thin film is configured to cover the phosphor layers 15 and the BM film 16 by a vapor deposition method, for example, thus forming a phosphor screen.

The metal back 17 is a light reflection film for allowing light which is emitted in the direction opposite to the face substrate 2, that is, toward the back substrate 1 side to reflect toward the face substrate 2 side thus enhancing an extraction efficiency of emitted light. The metal back 17 also has a function of preventing surfaces of phosphor particles from being charged.

Further, the metal back 17 is described as a surface electrode. However, the metal back 17 may be formed of stripe-shaped electrodes which intersect the scanning signal lines 9 and are divided for respective columns of pixels.

Further, with respect to these phosphors, for example, Y₂O₃:Eu, Y₂O₂S:Eu may be used as the red phosphor, ZnS:Cu, Al, Y₂SiO₅:Tb may be used as the green phosphor, and ZnS:Ag, Cl, ZnS:Ag, Al may be used as the blue phosphor. In the phosphor layers 15, an average particle diameter of the phosphor particles is set to 4 μm to 9 μm, for example, and a film thickness is set to approximately 10 μm to 20 μm, for example.

### Embodiment 2

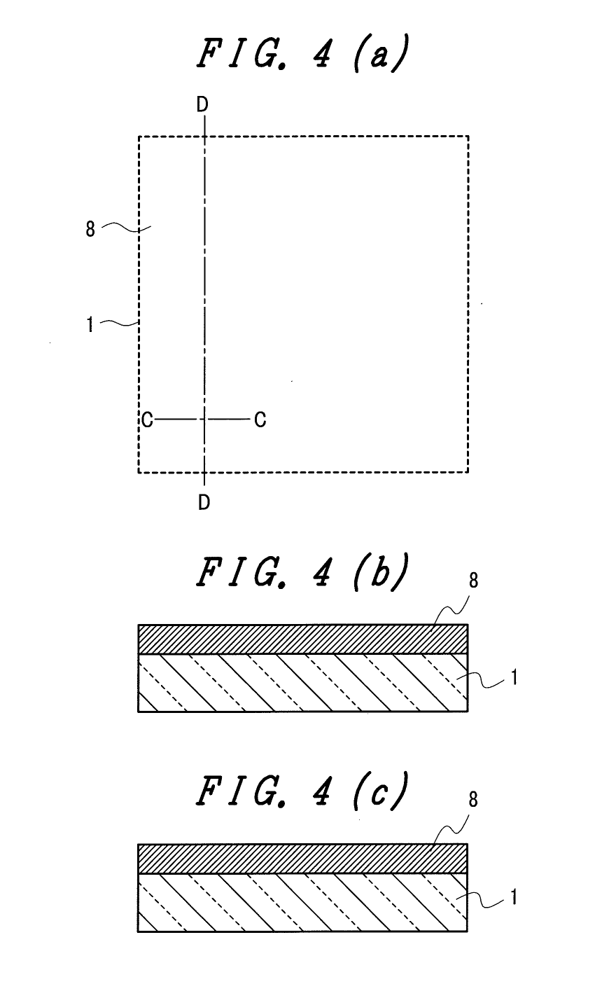

Next, an embodiment of a manufacturing method of the image display device according to the present invention is explained with respect to manufacturing steps of the both signal lines, the electron sources and the like described in the embodiment 1 in conjunction with FIG. 4 to FIG. 15.

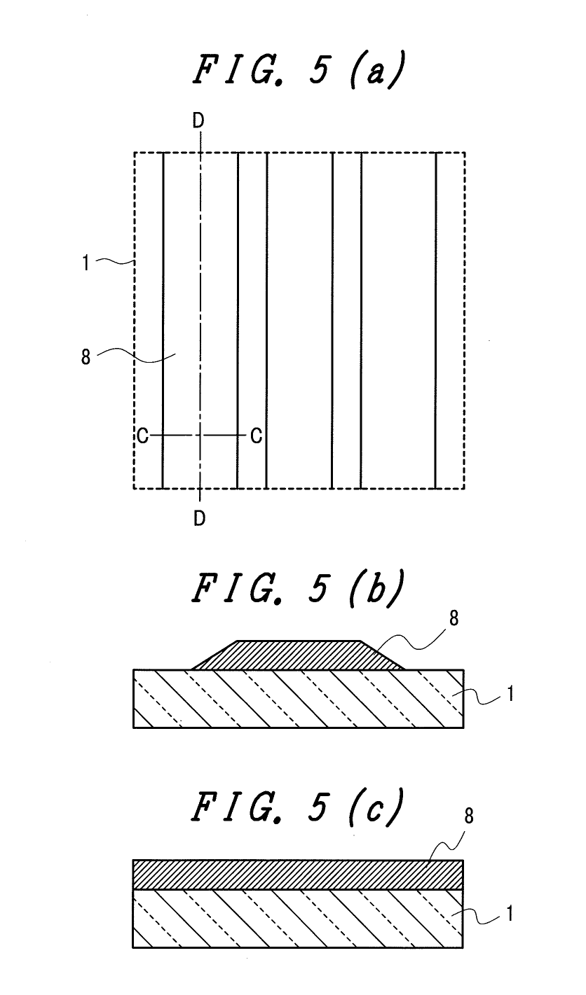

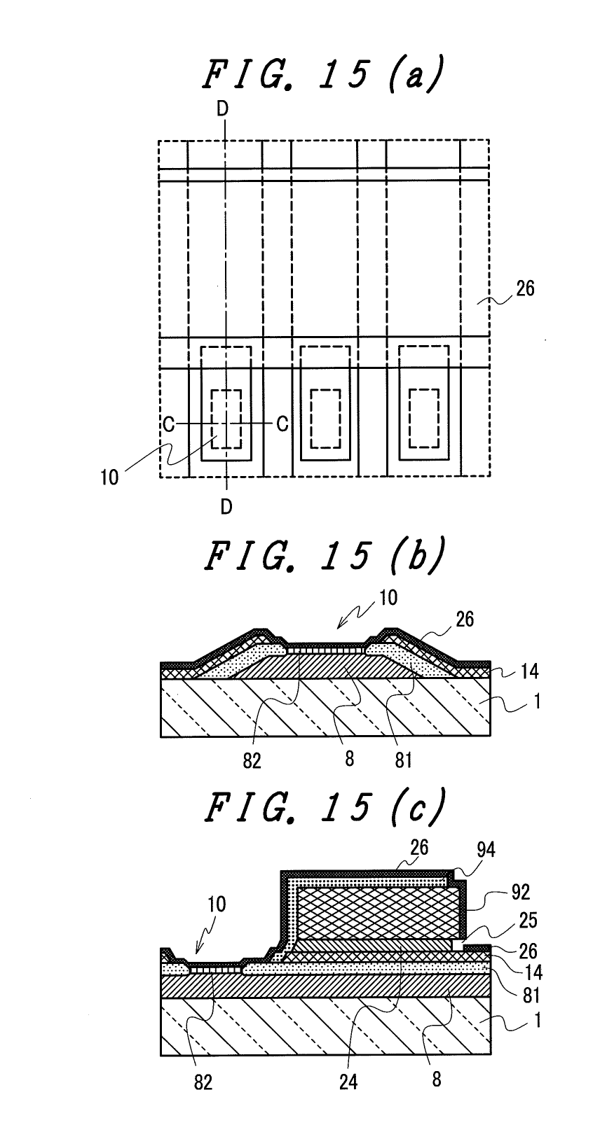

In FIG. 4A to FIG. 15C, FIG. 4A, FIG. 5A, . . . , and FIG. 15A are schematic plan views, FIG. 4B, FIG. 5B, . . . , and FIG. 15B are schematic cross-sectional views taken along a line C-C in FIG. 4A, FIG. 5A, . . . , and FIG. 15A, and FIG. 4C, FIG. 5C, and FIG. 15C are schematic cross-sectional views taken along a line D-D in FIG. 4A, FIG. 5A, . . . , and FIG. 15A. In the respective drawings, parts identical with the parts shown in the above-mentioned drawings are indicated by the same symbols. In the embodiment 2, the electron source is the MIM-type electron source.

First of all, as shown in FIG. 4A, FIG. 4B and FIG. 4C, a metal film for forming the video signal lines 8 is formed on almost the whole surface of an insulation substrate made of glass or the like which constitutes the back substrate 1. As a material of the video signal line 8, aluminum (Al) or aluminum alloy containing aluminum as a main component is used. Here, one of the reasons why Al is used as a material of the video signal line 8 is to make use of property of Al that an insulation film of good quality can be formed by anodization. Here, Al—Nd alloy doped with 2 atomic weight % of neodymium (Nd) is used. In forming the metal film for forming the video signal lines 8, a sputtering method is adopted, and a thickness of the metal film is set to 600 nm.

After forming the metal film, the stripe-shaped video signal lines 8 are formed in a patterning step and an etching step (see FIG. 5A, FIG. 5B and FIG. 5C).

Here, although a wiring width of each video signal line 8 differs depending on the size and the resolution of the image display device, the width may be set to an approximately arrangement pitch of the sub pixel, that is, approximately 100 to 200 μm. The etching may be wet etching which uses an aqueous mixture solution of phosphoric acid, acetic acid and nitric acid, for example. The video signal lines 8 have the large-width, simple stripe structure and hence, it is possible to perform a patterning of a resist using an inexpensive proximity exposure or an inexpensive printing method.

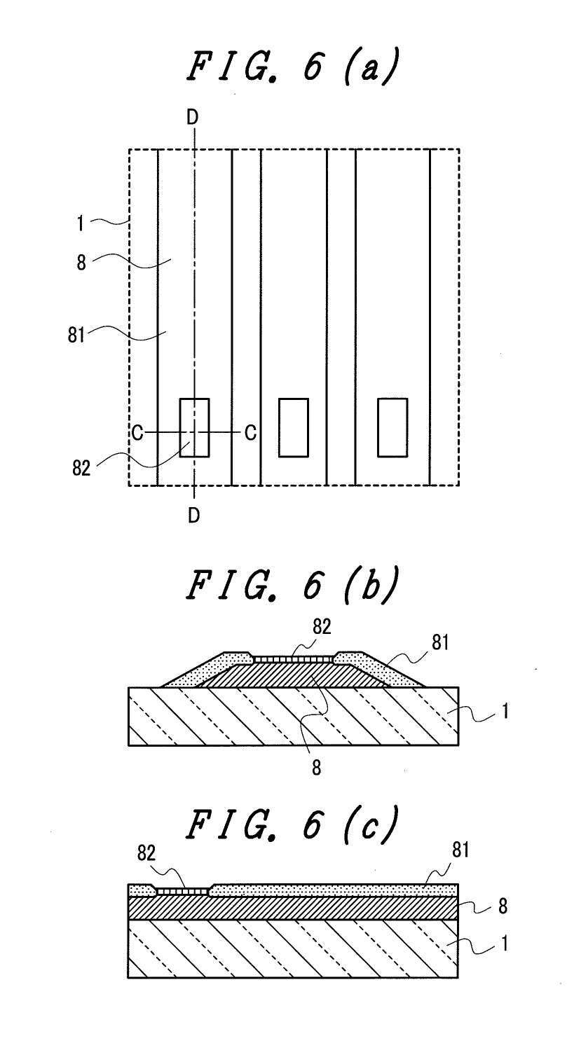

Next, on a front surface of the video signal lines 8, a field insulation film 81 which restricts an electron emission part and prevents the concentration of an electric field to edges of the video signal lines 8, and a tunnel insulation layer 82 are respectively formed (see FIG. 6A, FIG. 6B and FIG. 6C).

In this formation, first of all, portions of the video signal lines 8 each of which is arranged at a substantially center portion in the film width direction of the video signal line 8 shown in FIG. 6A, FIG. 6B and FIG. 6C and corresponds to a portion which is expected to become an electron emitting portion are masked by resist films, and other portions which are not masked by the resist films are selectively anodized with a large thickness thus forming the field insulation film 81 which becomes a protective insulation film. In this operation, when an anodizing voltage is set to 100V to 200V, the field insulation film 81 having a thickness of approximately 140 nm to 280 nm can be formed.

Thereafter, the resist film is removed and the remaining surfaces of the video signal lines 8 are anodized. For example, when the anodizing voltage is set to 6V, the tunnel insulation layer 82 having a thickness of approximately 10 nm is formed on the video signal lines 8 (see FIG. 6A, FIG. 6B and FIG. 6C).

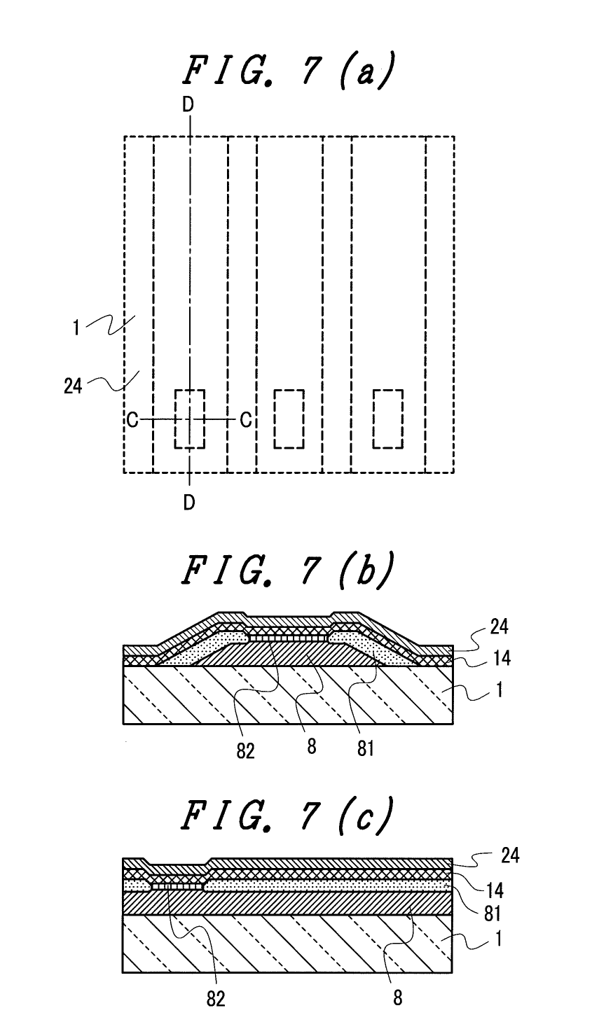

Next, the interlayer insulation film 14 is formed by a sputtering method, and a second insulation film 24 is formed on the interlayer insulation film 14 by a sputtering method (see FIG. 7A, FIG. 7B and FIG. 7C). In the formation of such films, a CVD method may be used.

When the second insulation film 24 is made of silicon (Si), as the material of the interlayer insulation film 14, a material such as silicon oxide, silicon nitride or the like having an etching rate different from an etching rate of a material of the second insulation film 24 is used.

The use of such a material is, as described later, for ensuring the etching selectivity which reduces an etching quantity of the interlayer insulation film 14 compared to an etching quantity of the second insulation film 24 when forming an undercut portion by etching the second insulation film 24 by dry etching.

Here, the interlayer insulation film 14 is formed of a silicon nitride film (SiN film) formed in the atmosphere of argon (Ar) and nitrogen (N₂) by a reactive sputtering method, wherein a thickness of the interlayer insulation film 14 is set to 200 nm.

When pin holes are present in the field insulation film 81 which is formed by the anodization, the interlayer insulation film 14 is filled in the pin holes thus maintaining the insulation between the video signal lines 8 and the scanning signal lines.

On the other hand, a Si film used as the second insulation film 24 is formed by a sputtering method in the atmosphere of Ar. A thickness of the second insulation film 24 is set to a value which falls within a range from 100 nm to 300 nm.

When the interlayer insulation film 14 is made of silicon oxide or silicon oxynitride, an etching speed of the interlayer insulation film 14 is further lowered compared to an etching speed of the interlayer insulation film 14 when the interlayer insulation film 14 is made of silicon nitride and hence, it is possible to acquire high selectivity between the interlayer insulation film 14 and the second insulation film 24.

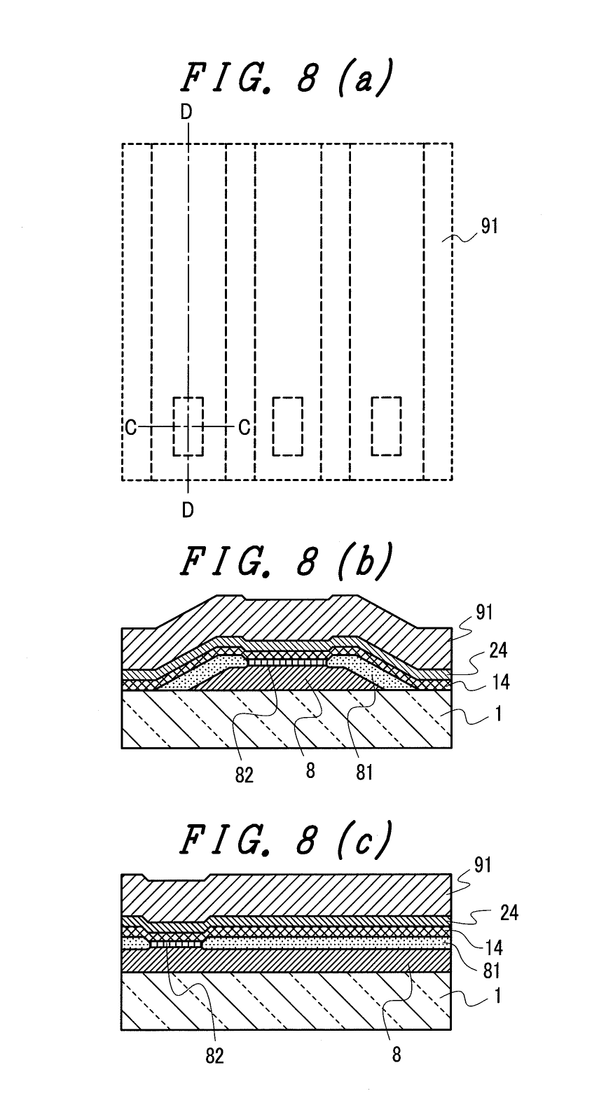

Next, an aluminum film 91 for forming the scanning signal lines 9 is formed by a sputtering method so as to cover the whole surface of the second insulation film 24. A thickness of the aluminum film 91 is set to 4.5 μm (see FIG. 8A, FIG. 8B and FIG. 8C).

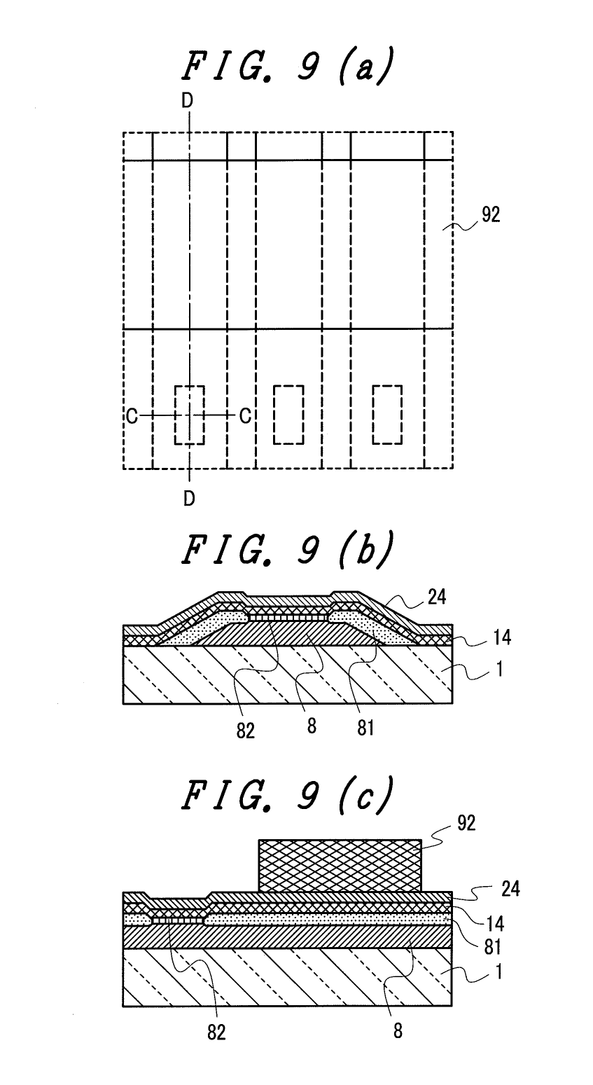

Subsequently, the aluminum film 91 is processed in a photo-etching step to form lower-layer films 92 of the stripe-shaped scanning signal lined 9 which extend in the direction orthogonal to the video signal lines 8 at positions between the tunnel insulation layers 82 and the tunnel insulation layers 82 (not shown in the drawing) arranged close to the tunnel insulation layers 82 with a predetermined distance therebetween and having the same color (see FIG. 9A, FIG. 9B and FIG. 9C). A cross section of the lower layer film 92 orthogonal to the extending direction is formed in an approximately rectangular shape.

Etching in this processing is wet etching using an aqueous mixture solution of phosphoric acid, acetic acid, and nitric acid, for example.

Aluminum is preferable as a scanning signal line material for forming the lower-layer film 92. This is because aluminum exhibits low resistance and aluminum can be easily processed by lowering the adhesiveness of a resist end surface with the adjustment of mixing ratios of phosphoric acid, acetic acid, and nitric acid of the etchant, to be more specific, the increase of a mixing ratio of nitric acid.

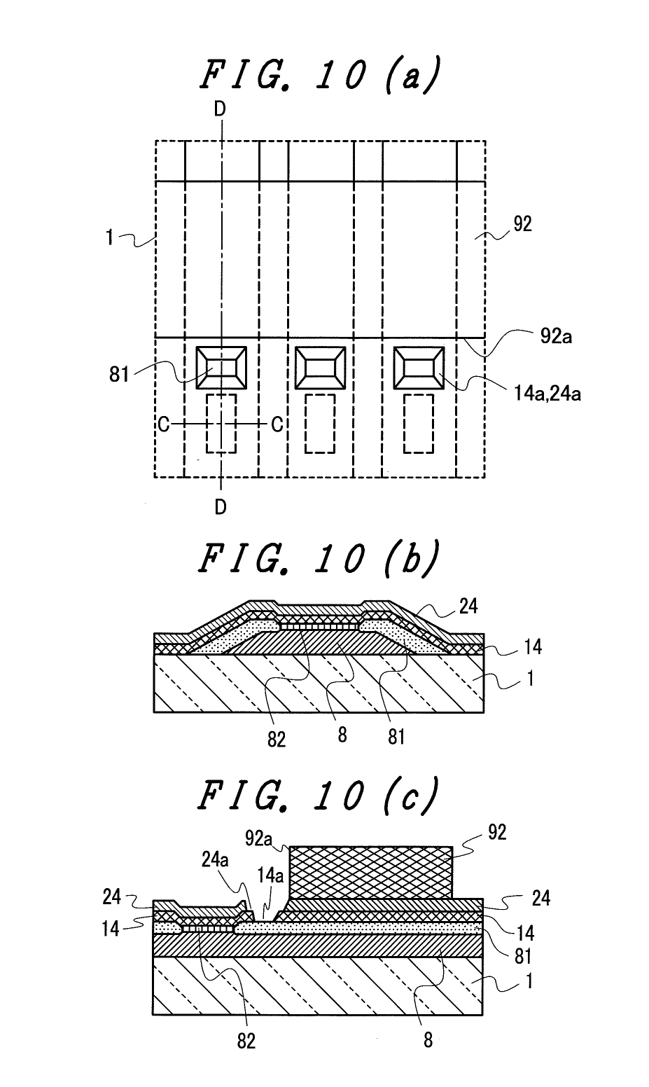

Next, openings which reach a surface of the field insulation film 81 are formed in the interlayer insulation film 14 and the second insulation film 24 (see FIG. 10A, FIG. 10B and FIG. 10C).

Here, the openings 14a, 24a having an approximately rectangular plane and an approximately bowl shape in the depth direction are formed approximately coaxially. The openings are formed by photolithography technique and dry etching.

The opening position is within a line width of the video signal line 8, and between one side wall 92a of the lower-layer film 92 and the tunnel insulation layer 82. The openings have side walls thereof tapered respectively, and are substantially treated as one opening having a continuous tapered portion in a stacked state. Further, the tapered portion and a film boundary portion are configured such that a metal film stacked above these portions hardly forms a broken step at such a portion.

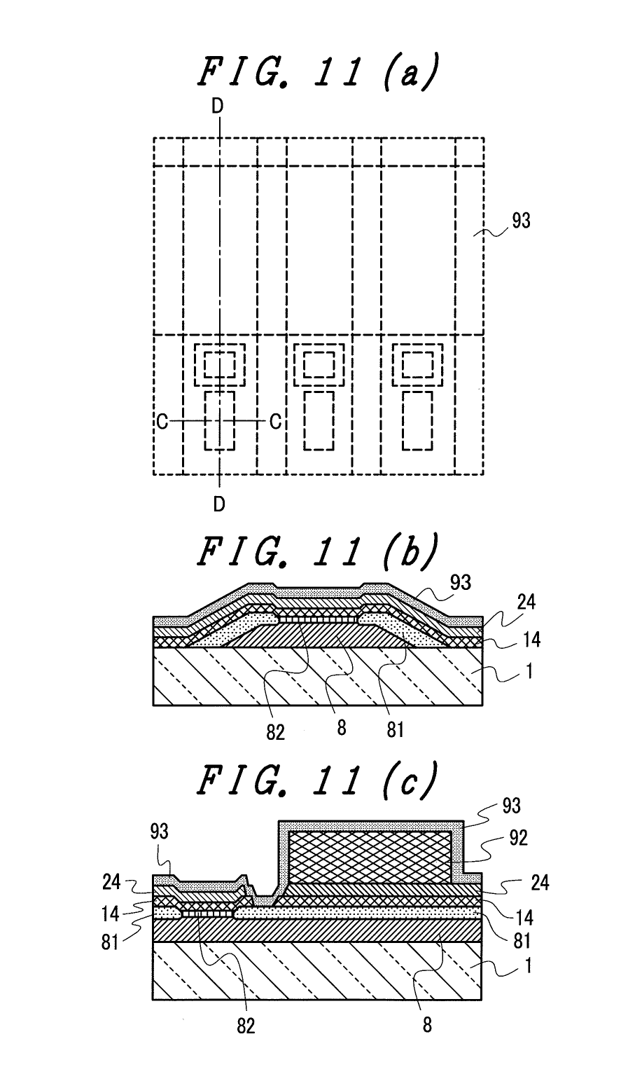

Subsequently, an aluminum alloy film 93 formed of aluminum alloy containing aluminum as a main component is formed over the whole surface above the lower-layer film 92, the openings and the like (see FIG. 11A, FIG. 11B and FIG. 11C).

The aluminum alloy film 93 is the above-mentioned alloy film made of aluminum doped with 2 atmic weight % of neodymium (Nd) and neodymium, and is formed by a sputtering method. A film thickness of the aluminum alloy film 93 is set to a value smaller than a film thickness of the lower-layer film 92, that is, a value which falls within a range from 300 nm to 600 nm.

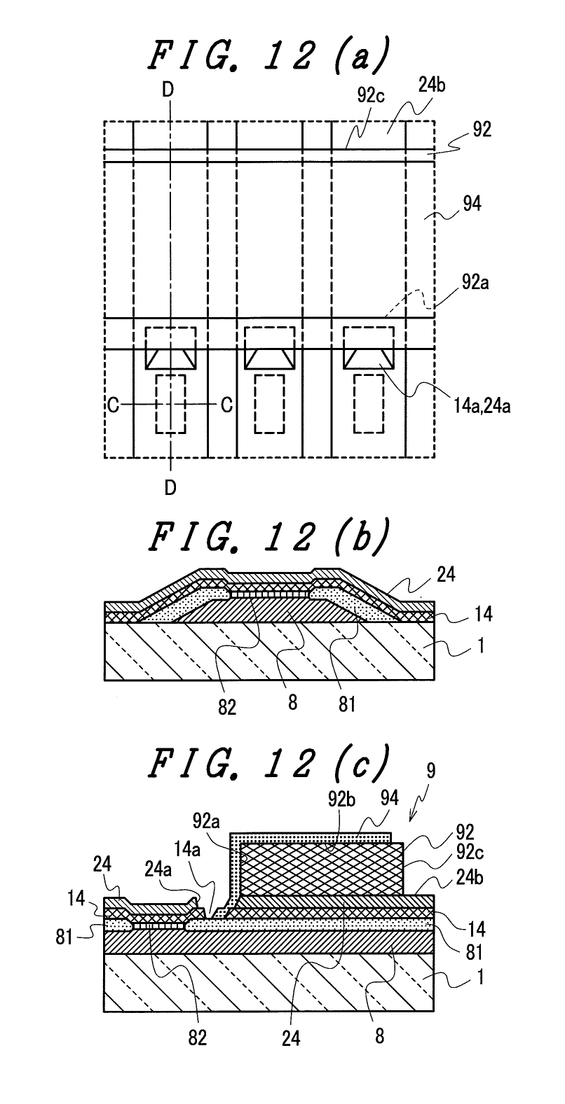

After forming the aluminum alloy film 93, using a photo etching step, an upper-layer film 94 of the scanning signal line 9 is continuously formed in a state that the upper-layer film 94 is stacked over a range extending from an upper surface 92b of the lower-layer film 92 to portions of the opening 14a and the opening 24a along one side wall 92a (see FIG. 12A, FIG. 12B and FIG. 12C).

On the other hand, another side wall 92c side of the lower-layer film 92 is configured such that the upper-layer film 94 is not present from a portion of the upper surface to the side wall by taking the above-mentioned separation of elements into consideration. Accordingly, the second insulation film 24 also exposes an intermediate portion 24b thereof which extends from an outer portion of the side wall 92c to the neighboring scanning signal line (not shown in the drawing) side.

The above-mentioned scanning signal line 9 is constituted of a stacked film formed of the upper-layer film 94 formed of the aluminum alloy film and the lower-layer film 92 formed of the aluminum film.

On the other hand, in forming the above-mentioned scanning signal line 9 in the stacked film structure formed of the aluminum film alloy film, the scanning signal line 9 is formed such that the specific resistance of the aluminum alloy film which constitutes the lower-layer film 92 is set smaller than the specific resistance of the aluminum alloy film which constitutes the upper-layer film 94.

Next, the selective dry etching of Si in the second insulation film is performed.

This selective dry etching of Si is performed using a mixture gas of CF₄ and O₂ or a mixture gas of SF₆ and O₂.

Although both of Si and SiN are etched using these gasses, it is possible to increase an etching selection ratio of Si by optimizing a ratio of O₂.

Due to such dry etching, a portion of the second insulation film 24 made of Si which is arranged on the interlayer insulation film 14 made of SiN is selectively removed.

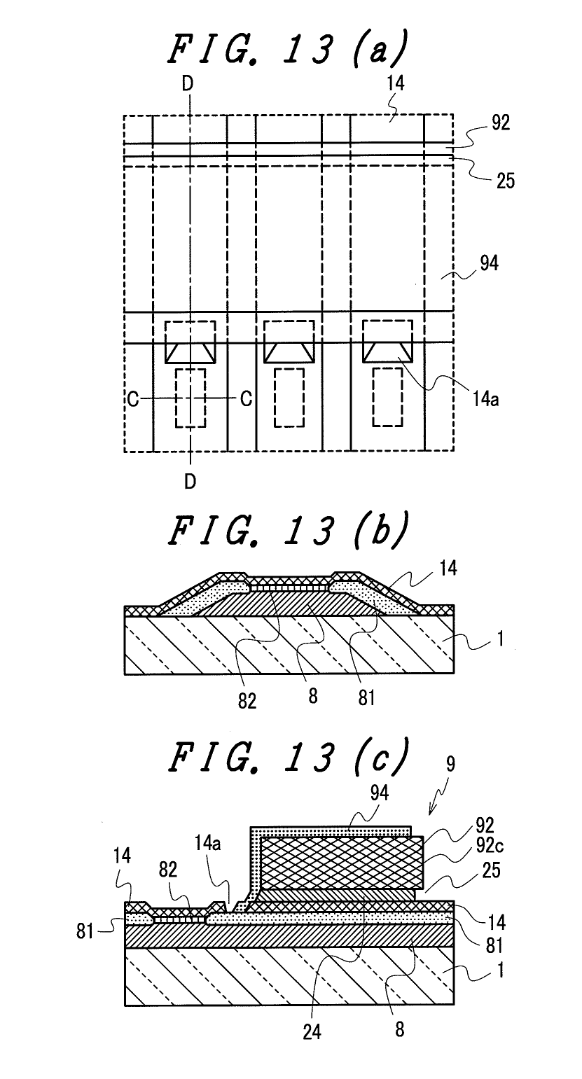

Due to this selective dry etching of Si, the exposed portion including the intermediate portion 24b is removed. Further, in addition to such removal of the exposed portion, a portion of the intermediate potion 24b contiguous with a lower side of the lower-layer film 92 is removed by side etching and hence, the lower-layer film 92 exhibits an eaves shape thus forming an undercut portion 25 (see FIG. 13A, FIG. 13B and FIG. 13C).

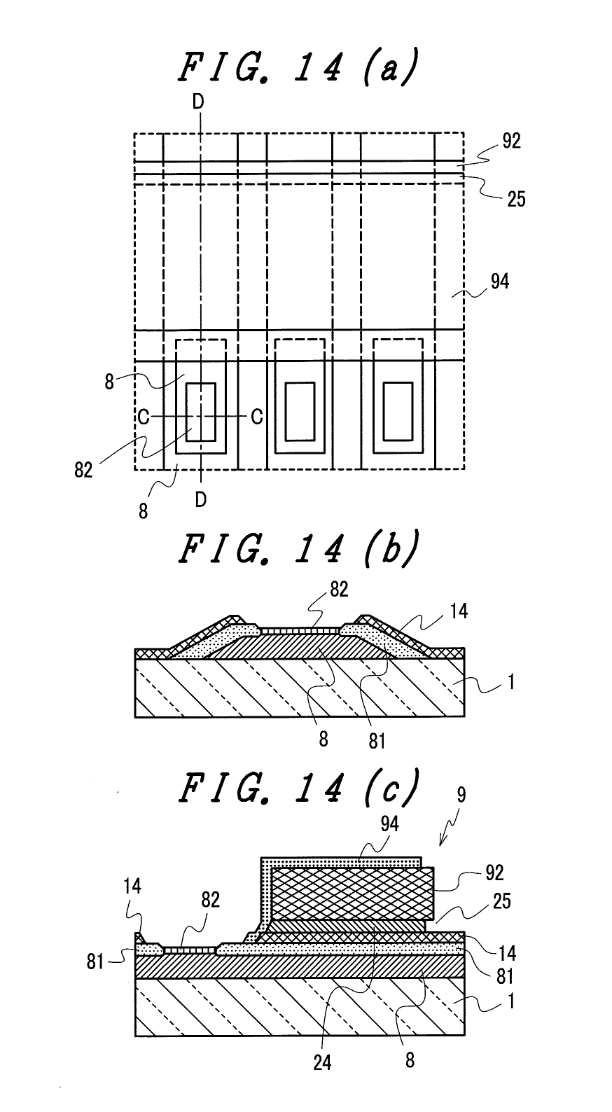

Next, the interlayer insulation film 14 is processed such that the interlayer insulation film 14 on the tunnel insulation layer 82 is removed thus exposing the tunnel insulation layer 82. Etching can be performed by dry etching which uses an etching gas containing CF₄ and SF₆as main components, for example (see FIG. 14A, FIG. 14B and FIG. 14C).

Next, the upper electrode 26 is formed. The upper electrode 26 is formed using a sputter film forming method, for example. The upper electrode 26 is formed of a stacked film made of iridium (Ir), platinum (Pt) and gold (Au), for example, and has a film thickness of 3 nm, for example.

The upper electrode 26 is formed in a shape which allows the upper electrode 26 to continuously cover a range extending from the tunnel insulation layer 82 to the field insulation film 81 and the upper-layer film 94, and is configured to be insulated from the neighboring scanning signal line not shown in the drawing by the above-mentioned undercut portion 25 (see FIG. 15A, FIG. 15B and FIG. 15C).

In the above-mentioned steps, the scanning signal lines 9, the video signal lines 8, the electron sources 10 and the upper electrodes 26 are respectively formed on the back substrate 1.

In this embodiment 2, a shape of the edge of the scanning signal line on a side at which the scanning signal line is conductive with the electron sources and a shape of the edge of the scanning signal line on a side at which the scanning signal line is not conductive with the electron source differ from each other thus making a cross-sectional shape of the scanning signal line in the thickness direction laterally asymmetrical with respect to a center axis of the line.

The conductive-side edge of the scanning signal line exhibits a tapered shape. In the non-conductive-side edge opposite to the conductive-side edge, the second insulation film is recessed by side etching and hence, the scanning signal line exhibits the eaves shape.

Due to the difference in edge shape, the upper electrode is continuously formed from the scanning signal line to the electron source in the conductive-side edge, while the upper electrode is separated by the undercut portion in the non-conductive-side edge thus establishing the element separation which makes the neighboring electron sources non-conductive with each other.

### Embodiment 3

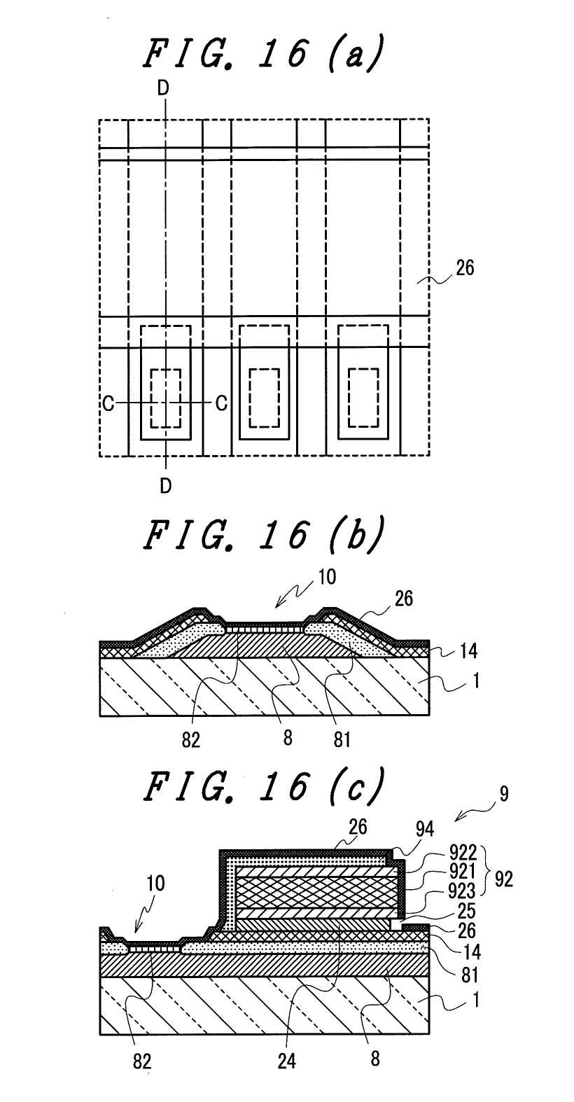

FIG. 16A, FIG. 16B and FIG. 16C are schematic views for explaining manufacturing steps in another embodiment of the image display device according to the present invention corresponding to FIG. 15A, FIG. 15B and FIG. 15C, wherein FIG. 16A is a plan view, FIG. 16B is a schematic cross-sectional view taken along a line C-C in FIG. 16A and FIG. 16C is a cross-sectional view taken along a line D-D in FIG. 16A. In the respective drawings, parts identical with the parts shown in the above-mentioned drawings are indicated by the same symbols.

In FIG. 16A to FIG. 16C, the scanning signal line 9 is formed of a four-layered film.

First of all, the lower-layered film 92 is formed of a three-layered film which is formed by sandwiching an aluminum film 921 by aluminum alloy films 922, 923 containing aluminum as a main component from above and below, and an upper-layer film 94 formed of an aluminum alloy film containing aluminum as a main component is formed on an upper side of the lower-layered film 92 thus forming the four-layered film constitution.

According to the constitution of the embodiment 3, in addition to the technical feature that the scanning signal line is made of aluminum and aluminum alloy, the embodiment 3 also has the technical feature that the aluminum alloy film 923 which is brought into contact with the second insulation film 24 maintains an eaves shape in a heating step thus contributing to the assurance of reliability of element separation.

### Embodiment 4

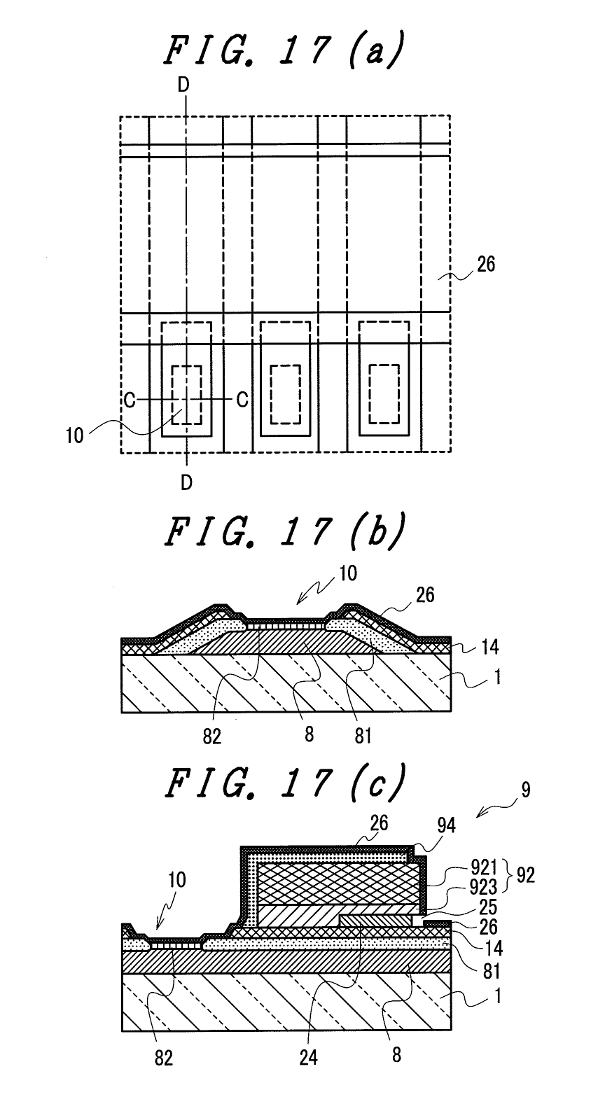

FIG. 17A, FIG. 17B and FIG. 17C are schematic views for explaining another embodiment of the manufacturing method of the image display device according to the present invention, wherein FIG. 17A is a plan view, FIG. 17B is a cross-sectional view taken along a line C-C in FIG. 17A, and FIG. 17C is a cross-sectional view taken along a line D-D in FIG. 17A, and in the respective drawings, parts identical with the parts shown in the above-mentioned drawings are indicated by the same symbols.

In FIG. 17A to FIG. 17C, a scanning signal line 9 is formed of a three-layered film.

A lower-layered film 92 is formed of a two-layered film which has an aluminum alloy film 923 containing aluminum as a main component on a lower surface of an aluminum film 921. The three-layered film is constituted by forming an upper-layered film 94 formed of an aluminum alloy film containing aluminum as a main component on an upper side of the lower-layered film 92.

The constitution of this embodiment 4 also can acquire advantageous effects substantially equal to the advantageous effects of the embodiment 3.

### Embodiment 5

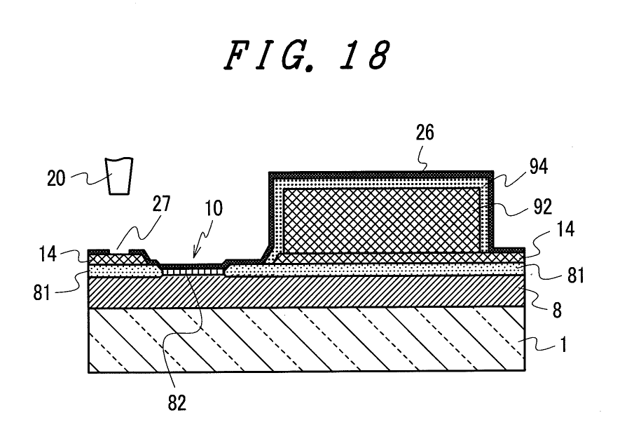

FIG. 18 is a schematic cross-sectional view for explaining another embodiment of the image display device according to the present invention, and in the drawing, parts identical with the parts shown in the above-mentioned drawings are indicated by the same symbols.

In the embodiment 5, as shown in FIG. 18, an upper electrode 26 has a gap strip region 27 arranged on an interlayer insulation film 14, and the element separation is performed by this gap strip region 27.

The gap strip region 27 is formed by cutting a portion of the upper electrode 26 on the interlayer insulation film 14 using laser beams 28.

This embodiment 5 performs the element separation using the technique different from the undercut technique adopted by the above-mentioned embodiments 1 to 4 thus simplifying the element constitution, enhancing a yield rate of products, and shortening operation steps.

In the above-mentioned embodiments, the explanation has been made by taking the structure which uses the MIM-type electron source as the electron source as an example. However, the present invention is not limited to this, and is also applicable to a self-luminous-type FPD which uses the above-mentioned various electron sources in the same manner.

Further, although the explanation has been made by taking aluminum alloy which contains neodymium as an example, the present invention is not limited to this, and it is possible to use various aluminum alloy containing several % or less than several % of Ta, Cu, Si or the like, for example, when necessary.

What is claimed is:

1. An image display device comprising:
a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of intersecting portions of the video signal lines and the scanning signal lines and connected to the scanning signal lines thereon;
a face substrate which mounts phosphor layers formed corresponding to the electron sources and an anode for applying an acceleration voltage so as to direct electrons emitted from the electron sources to the phosphor layers thereon;
a frame body being arranged between the face substrate and the back substrate for holding a predetermined distance between the both substrates; and
a sealing material for hermetically sealing the frame body and the both substrates, wherein
the scanning signal line has the stacked film structure constituted of an aluminum film and an aluminum alloy film containing aluminum as a main component.

2. An image display device according to claim 1, wherein the scanning signal line has the two-layered film structure in which the aluminum film constitutes a lower layer and the aluminum alloy film containing aluminum as a main component constitutes an upper layer.

3. An image display device according to claim 1, wherein a lower layer of the scanning signal line has the three-layered film structure which arranges the aluminum film between the aluminum alloy films containing aluminum as a main component, and the aluminum alloy film is formed on the lower layer as an upper layer of the scanning signal line thus forming the four-layered film structure.

4. An image display device according to claim 1, wherein a lower layer of the scanning signal line has the two-layered film structure which arranges the aluminum alloy film containing aluminum as a main component below the aluminum film, and the aluminum alloy film is formed on the lower layer as an upper layer of the scanning signal line thus forming the three-layered film structure.

5. An image display device according to claim 1, wherein the scanning signal line is configured such that a film thickness of the aluminum film is larger than a film thickness of the aluminum alloy film.

6. An image display device comprising:
a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of intersecting portions of the video signal lines and the scanning signal lines and connected to the scanning signal lines thereon;
a face substrate which mounts phosphor layers formed corresponding to the electron sources and an anode for applying an acceleration voltage so as to direct electrons emitted from the electron sources to the phosphor layers thereon; and
a frame body provided being arranged between the face substrate and the back substrate for holding a predetermined distance between the both substrates;
a sealing material for hermetically sealing the frame body and the both substrates, wherein
the scanning signal line has the stacked film structure constituted of an aluminum alloy film containing aluminum as a main component, and includes a plurality of layers which have different specific resistances in the stacked film structure.

7. An image display device according to claim 6, wherein the scanning signal line has the two-layered film structure which arranges the film having a large specific resistance above the film having a small specific resistance in the stacked film structure.

8. An image display device according to claim 6, wherein the scanning signal line has the three-or-more layered film structure which arranges the film having a large specific resistance on an upper side and a lower side of the layered film structure and one or more films having a small specific resistance between the upper-side layer and the lower-side layer in the stacked film structure.

9. A manufacturing method of an image display device which includes: a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of intersecting portions of the video signal lines and the scanning signal lines and connected to the scanning signal lines thereon;
a face substrate which mounts phosphor layers formed corresponding to the electron sources and an anode for applying an acceleration voltage so as to direct electrons emitted from the electron sources to the phosphor layers thereon;
a frame body provided being arranged between the face substrate and the back substrate for holding a predetermined distance between the both substrates; and
a sealing material for hermetically sealing the both substrates and the frame body, the manufacturing method comprising the steps of:
forming stripe-shaped video signal lines which have a tunnel insulation layer and a field insulation layer thereon on an insulation substrate constituting the back substrate;
covering the video signal lines with the interlayer insulation film;
forming a second insulation film having an etching rate different from an etching rate of the interlayer insulation film on the interlayer insulation film,
forming a stripe-shaped lower-layer film constituting some of the scanning signal lines substantially orthogonal to the video signal lines on the second insulation film, the stripe-shaped lower-layer film formed of an aluminum film;
forming openings in portions of the interlayer insulation film and the second insulation film;
covering the lower-layer film and a surface having openings or the like with a metal thin film made of aluminum alloy containing aluminum as a main component;
forming an upper-layer film which continuously covers the lower-layer film ranging from an upper surface to one side wall of the lower-layer film by processing the metal thin film;
forming an undercut portion in a lower portion of another side wall of the lower-layer film by removing a portion of the second insulation film;
exposing the tunnel insulation layer for the video signal lines by removing a film stacked on the tunnel insulation layer;
forming an upper electrode film over a range extending from the tunnel insulation layer to the scanning signal lines;
separating elements between the neighboring scanning signal lines by dividing the upper electrode film at the undercut portion, and forming an upper electrode which extends continuously from the tunnel insulation layer to a top surface by way of the one side wall of the scanning signal lines.

10. A manufacturing method of an image display device which includes: a back substrate which mounts a plurality of video signal lines extending in one direction and being arranged parallel to each other in another direction orthogonal to the one direction, a plurality of scanning signal lines extending in the another direction and being arranged parallel to each other in the one direction such that the scanning signal lines intersect the video signal lines, an interlayer insulation film disposed between the scanning signal lines and the video signal lines, and electron sources provided in the vicinity of intersecting portions of the video signal lines and the scanning signal lines and connected to the scanning signal lines thereon;
a face substrate which mounts phosphor layers formed corresponding to the electron sources and an anode for applying an acceleration voltage so as to direct electrons emitted from the electron sources to the phosphor layers thereon;
a frame body provided being arranged between the face substrate and the back substrate for holding a predetermined distance between the both substrates; and
a sealing material for hermetically sealing the both substrates and the frame body, the manufacturing method comprising the steps of:
forming stripe-shaped video signal lines which have a tunnel insulation layer and a field insulation layer thereon on an insulation substrate constituting the back substrate;
covering the video signal lines with the interlayer insulation film;
forming a second insulation film having an etching rate different from an etching rate of the interlayer insulation film on the interlayer insulation film,
forming a stripe-shaped lower-layer film constituting some of the scanning signal lines substantially orthogonal to the video signal lines on the second insulation film, the stripe-shaped lower-layer film formed of an aluminum alloy film containing aluminum as a main component;
forming openings at portions of the interlayer insulation film and the second insulation film;
covering the lower-layer film and a surface having openings or the like with a metal thin film made of aluminum alloy containing aluminum as a main component and having specific resistance different from specific resistance of the aluminum alloy film which constitutes the lower-layer film;
forming an upper-layer film which continuously covers the lower-layer film ranging from an upper surface to one side wall of the lower-layer film by processing the metal thin film;
forming an undercut portion in a lower portion of another side wall of the lower-layer film by removing a portion of the second insulation film;
exposing the tunnel insulation layer by removing a film stacked on the tunnel insulation layer of the video signal line;
forming an upper electrode film over a range extending from the tunnel insulation layer to the scanning signal lines;
separating elements between the neighboring scanning signal lines by dividing the upper electrode film at the undercut portion, and forming an upper electrode which extends continuously from the tunnel insulation layer to a top surface by way of one side wall of the scanning signal lines.
